(19) United States
(12) Patent Application Publication
(10) Pub. No.: US 2008/0031128 A1
(43) Pub. Date: Feb. 7, 2008

(54) APPARATUS AND METHOD FOR TRANSMITTING UPLINK DATA IN BROADBAND WIRELESS COMMUNICATION SYSTEM

(75) Inventors: Jae-Hyuk Jang, Suwon-si (KR); Jung-Je Son, Seongnam-si (KR); Nam-Gi Kim, Suwon-si (KR); Min-Hee Cho, Suwon-si (KR)

Correspondence Address: Jefferson IP Law, LLP, 1730 M Street, NW, Suite 807, Washington, DC, 20036, US

(73) Assignee: Samsung Electronics Co., LTD., Suwon-City (KR)

(21) Appl. No.: 11/832,846

(22) Filed: Aug. 2, 2007

(30) Foreign Application Priority Data
Aug. 3, 2006 (KR) 2006-0073247

(51) Int. Cl. H04J 11/00; H04Q 7/00

(52) U.S. Cl. 370/210; 370/329; 370/331

(57) ABSTRACT

An apparatus and method for transmitting uplink data by a subscriber station in a broadband wireless communication system are provided. The apparatus includes a generator for generating a random access message including uplink bandwidth allocation request information when in an idle mode, a processor for determining an uplink bandwidth allocated by analyzing a bandwidth allocation message received from a base station, and a transmitter for transmitting data by using the allocated uplink bandwidth.

### PRIORITY

This application claims the benefit under 35 U.S.C. §119(a) to a Korean patent application filed in the Korean Intellectual Property Office on Aug. 3, 2006 and assigned Serial No. 2006-0073247, the entire disclosure of which is hereby incorporated by reference.

### BACKGROUND OF THE INVENTION

1. Field of the Invention

The present invention relates to a broadband wireless communication system. More particularly, the present invention relates to an apparatus and method for transmitting uplink data by a subscriber station operating in an idle mode in a broadband wireless communication system.

2. Description of the Related Art

In a next generation communication system, also known as the 4^{th} Generation (4G) communication system, researches are actively in progress to provide a Quality of Service (QoS) with a data transfer speed of about 100 Mbps. In particular, in a Broadband Wireless Access (BWA) system, such as a wireless Local Area Network (LAN) system and a wireless Metropolitan Area Network (MAN) system, there are researches on a communication system supporting a high speed service at the same time of providing mobility and ensuring QoS. An example of such a communication system is an Institute of Electrical and Electronics Engineers (IEEE) 802.16e communication system, which standard is hereby incorporated by reference.

In the IEEE 802.16e communication system, a Subscriber Station (SS) operates in ether a normal mode or an idle mode. The normal mode is defined as a state in which communication is achieved between the SS and a Base Station (BS). When in the normal mode, the SS is assigned with a Connection IDentifier (CID) by the BS. Then, the SS receives a frame MAP, and transmits/receives data and control signals. In addition, in the idle mode, only the most essential signals are periodically exchanged between the SS and the BS, for example, when location information of the SS is updated, or when downlink data is detected. The CID is not assigned to the SS operating in the idle mode, and thus data communication cannot be made in the idle mode. Accordingly, to enable data communication, the SS has to change from the idle mode to the normal mode.

FIG. 1 illustrates a conventional process of exchanging signals between an SS and a BS when uplink data is transmitted in a broadband wireless communication system. It will be assumed hereinafter that the uplink data is a Short Message Service (SMS) message.

Referring to FIG. 1, an SS 110 for operating in an idle state transmits a ranging code to a BS 120 so that a bandwidth is allocated for initial ranging. As a result, the BS 120 allocates the bandwidth for initial ranging to the SS 110 in step 101.

Next, the SS 110 transmits a Ranging Request (RNG-REQ) message to the BS 120 by using the allocated bandwidth, and the BS 120 transmits a Ranging Response (RNG-RSP) message to the SS 110, thereby performing a ranging process in step 103.

After completing the ranging process, the SS 110 transmits an SS Basic Capability Negotiation Request (SBC-REQ) message to the BS 120, and the BS 120 transmits an SS Basic Capability Response (SBC-RSP) message to the SS 110, thereby performing a basic capability negotiation process in step 105.

Next, the SS 110 and the BS 120 perform an authentication and encryption key exchange process. That is, the SS 110 and the BS 120 exchange a Privacy Key Management Request (PKM-REQ) message and a Privacy Key Management Response (PKM-RSP) message, thereby performing a communication authentication process in step 107.

After completing the authentication and encryption key exchange process, the SS 110 and the BS 120 perform a registration process. In this process, the SS 110 and the BS 120 exchange a Registration Request (REG-REQ) message and a Registration Response (REG-RSP) message, and as a result, a CID is assigned to the SS 110 instep 109.

Next, the SS 110 requests the BS 120 to allocate an uplink bandwidth so as to transmit the SMS message in step 111. Herein, the uplink bandwidth is allocated corresponding to a size of data to be transmitted.

Upon receiving the uplink bandwidth allocation request, the BS 120 allocates the requested bandwidth, and an MAP message is broadcast to inform the allocation of bandwidth in step 113.

Upon receiving the MAP message, the SS 110 determines the allocated uplink bandwidth, and transmits the SMS message by using the allocated uplink bandwidth in step 115.

If no data is transmitted/received for a predetermined length of time after the SS 110 transmits the SMS message, the SS 110 and the BS 120 perform an idle mode transition process in step 117.

As described above, in a broadband wireless communication system, since an SS operating in the idle mode transmits data after being transitioned to a normal mode, many steps have to be performed for a simple service such as SMS message transmission. This results in a significant overhead to the SS and the BS. Further, such a transition requires a large amount of power consumption.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for reducing overhead of a Subscriber Station (SS) and a Base Station (BS) and decreasing power consumption of the SS in a broadband wireless communication system.

Another aspect of the present invention is to provide an apparatus and method for transmitting uplink data by an SS operating in an idle mode in a broadband wireless communication system.

Another aspect of the present invention is to provide an apparatus and method for transmitting an initial ranging message including an uplink bandwidth allocation request by an SS in a broadband wireless communication system.

Another aspect of the present invention is to provide an apparatus and method for transmitting data by using an uplink control region by an SS operating in an idle mode in a broadband wireless communication system.

According to an aspect of the present invention, an apparatus of a subscriber station in a wireless communication system is provided. The apparatus includes a generator for generating a random access message including uplink bandwidth allocation request information when in an idle mode, a processor for determining an uplink bandwidth allocated by analyzing a bandwidth allocation message received from a base station, and a transmitter for transmitting data by using the allocated uplink bandwidth.

According to an aspect of the present invention, an apparatus of a base station in a wireless communication system is provided. The apparatus includes a processor for analyzing a random access message received from a subscriber station in an idle mode and determining an uplink bandwidth allocation request of the subscriber station, a scheduler for allocating a bandwidth according to the uplink bandwidth allocation request, and a receiver for receiving data from the subscriber station by using the allocated bandwidth.

According to an aspect of the present invention, a method of transmitting data by a subscriber station in a wireless communication system is provided. The method includes generating a random access message including uplink bandwidth allocation request information when in an idle mode, determining an uplink bandwidth allocated by analyzing a bandwidth allocation message received from a base station, and transmitting data by using the allocated uplink bandwidth.

According to an aspect of the present invention, a method of receiving data by a base station in a wireless communication system is provided. The method includes determining an uplink bandwidth allocation request of a subscriber station by analyzing a random access message received from the subscriber station in an idle mode, allocating a bandwidth according to the uplink bandwidth allocation request, and receiving data from the subscriber station by using the allocated bandwidth.

### BRIEF DESCRIPTION OF THE DRAWINGS

The above and other aspects, features and advantages of certain exemplary embodiments of the present invention will become more apparent from the following detailed description when taken in conjunction with the accompanying drawings in which:

FIG. 1 illustrates a conventional process of exchanging signals between a Subscriber Station (SS) and a Base Station (BS) when uplink data is transmitted in a broadband wireless communication system;

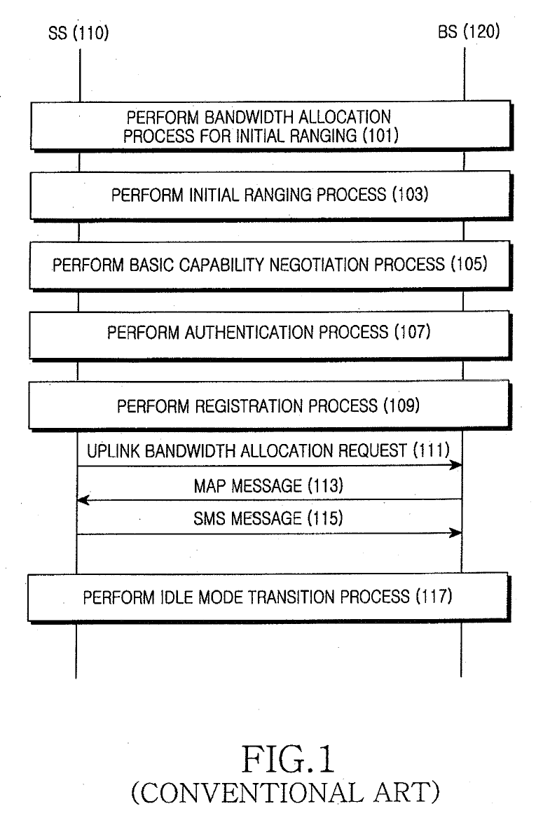

FIG. 2 is a block diagram of an SS in a broadband wireless communication system according to an exemplary embodiment of the present invention;

FIG. 3 is a block diagram of a BS in a broadband wireless communication system according to an exemplary embodiment of the present invention;

FIG. 4 illustrates a process of exchanging signals between an SS and a BS in a broadband wireless communication system when uplink data is transmitted according to an exemplary embodiment of the present invention;

FIG. 5 is a flowchart illustrating a process of transmitting uplink data by an SS in a broadband wireless communication system according to an exemplary embodiment of the present invention; and

FIG. 6 is a flowchart illustrating a process of receiving uplink data by a BS in a broadband wireless communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of the exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

A technique will be described hereinafter in which a Subscriber Station (SS) operating in an idle mode transmits uplink data in a broadband wireless communication system. Although the broadband wireless communication system to be described below is an Orthogonal Frequency Division Multiplexing (OFDM) communication system, this is for exemplary purpose only. Thus, the present invention may also be applied to other types of cellular-based communication systems, for example those using a relay station.

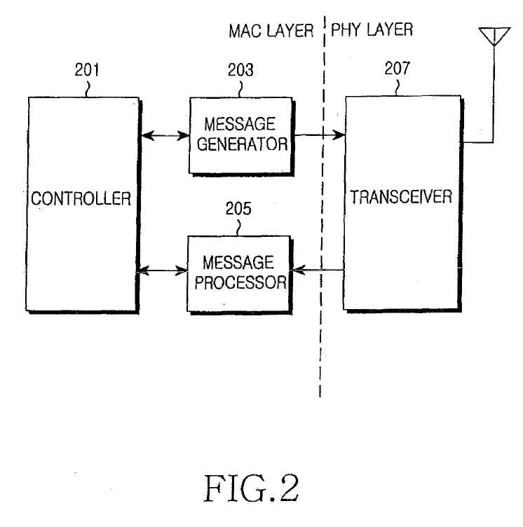

FIG. 2 is a block diagram of an SS in a broadband wireless communication system according to an exemplary embodiment of the present invention.

Referring to FIG. 2, the SS includes a controller 201, a message generator 203, a message processor 205, and a transceiver 207.

The controller 201 is a Media Access Control (MAC) protocol controller and controls general MAC protocol operations. For example, the controller 201 generates an uplink message and analyzes a downlink message. In particular, according to an exemplary embodiment of the present invention, upon detecting data (e.g., Short Message Service (SMS) message) to be transmitted in the idle mode, the controller 201 controls a data transmission function in the idle mode.

The message generator 203 generates an uplink message containing control information or data under the control of the controller 201. In particular, when the SS attempts to transmit the uplink data in the idle mode according to an exemplary embodiment of the present invention, the message generator 203 generates an initial ranging message containing an uplink bandwidth allocation request. For example, the message generator 203 generates an initial ranging message containing Type Length Value (TLV) elements as shown in Tables 1 and 2 below.

TABLE 1

| Name | Type | Length | Value |
|---|---|---|---|
| Ranging | 6 | 1 | Bit #0: HO indication |
| Purpose | | | Bit #1: Location Update Request |
| Indication | | | Bit #2: Short Data TX Request |
| | | | Bit #3-7: Reserved |

Table 1 shows a configuration of a Ranging Purpose Indication TLV included in a Ranging Request (RNG-REQ) message for initial ranging. Herein, in the Ranging Purpose Indication TLV, a first bit (Bit #0) is used to indicate a Hand Over (HO) message, a second bit (Bit #1) is used to indicate an SS location information update message, a third bit (Bit #2) is used to indicate a message for uplink data to be transmitted in an idle mode, and remaining bits (Bits #3 to #7) are reserved.

TABLE 2

| Name | Type | Length | Value |
|---|---|---|---|
| Uplink | 22 | 2 | Bit #0-10: Bandwidth Request |
| Bandwidth | | | Bit #11-15: Reserved |
| Request | | | |

Table 2 shows a configuration of an Uplink Bandwidth Request TLV included in the RNG-REQ message for initial ranging. The Uplink Bandwidth Request TLV represents amount of bandwidths requested when the uplink data is transmitted in the idle mode according to an exemplary embodiment of the present invention. Herein, the 1st to 11th bits (Bits #0 to #10) denote bandwidth request and remaining bits (Bits #11 to #15) are reserved.

For example, when the uplink data is transmitted in the idle mode, the message processor 205 generates an RNG-REQ message containing a Ranging Purpose Indication TLV composed of ‘0b0x1xxxxx’ and an Uplink Bandwidth Request TLV in which bandwidth request is recorded. Herein, ‘x’ denotes ‘Don't Care’.

In addition, the message processor 205 generates a packet (e.g., MAC Provide Data Unit (PDU)) containing the uplink data to be transmitted. In this case, a CID may be set to an initial ranging CID (‘0x0000’) which is one of pre-defined general purpose CIDs or may be set to a CID defined to transmit data in the idle mode.

The message processor 205 analyzes a message (e.g., MAP message) received from the BS under the control of the controller 201, and provides it to the controller 201. For example, bandwidth allocation information of the SS is determined using the MAP message received from the BS and the result is provided to the controller 201.

The transceiver 207 includes an encoder/decoder (not shown) for encoding/decoding a bit-stream at a corresponding encoding rate, an OFDM modulator/demodulator for transforming an OFDM symbol to/from sub-carrier data by using an Inverse Fast Fourier Transform (IFFT)/Fast Fourier Transform (FFT) operation, a Digital-Analog Converter (DAC)/Analog-Digital Converter (ADC) for converting an analog/digital signal to/from a digital/analog signal, and an Radio Frequency (RF) processor for transforming a base-band signal to/from an RF signal. Further, the transceiver 207 processes a message exchanged between the SS and the BS by using a corresponding message used in the communication system, and thus transmits/receives it through an antenna.

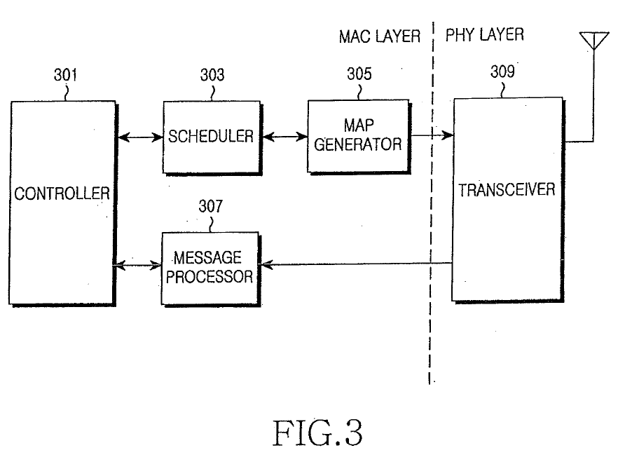

FIG. 3 is a block diagram of a BS in a broadband wireless communication system according to an exemplary embodiment of the present invention.

Referring to FIG. 3, the BS includes a controller 301, a scheduler 303, a MAP generator 305, a message processor 307, and a transceiver 309.

The controller 301 is an MAC protocol controller and controls general MAC protocol operations. For example, the controller 301 controls an allocation of bandwidths of a plurality of SSs connectable to the BS, the generation and transmission of a downlink message, and the analysis of an uplink message. In particular, upon receiving a ranging message from the SS according to an exemplary embodiment of the present invention, the controller 301 allows an uplink bandwidth allocation request included in the ranging message to be determined and an MAP message to be generated by allocating bandwidths according to the request.

The scheduler 303 schedules the allocation of bandwidths of the SSs connectable to the BS under the control of the controller 301. In particular, according to an exemplary embodiment of the present invention, when an SS operating in the idle mode requests the uplink bandwidth allocation by using the ranging message including the TLV elements shown in Tables 1 and 2 mentioned above, the scheduler 303 allocates an uplink bandwidth to the SS through a fast ranging Information Element (IE) by using an SS's MAC address included in the ranging message. Since an uplink data burst region cannot be allocated without a CID, the scheduler 303 allocates an assignable fast ranging region by using the MAC address.

The MAP generator 305 receives bandwidth allocation scheduling information from the scheduler 303 and generates an MAP message. The message processor 307 analyzes messages received from a plurality of SSs and provides the messages to the controller 301.

The transceiver 309 includes an encoder/decoder (not shown) for encoding/decoding a bit-stream at a corresponding encoding rate, an OFDM modulator/demodulator for transforming an OFDM symbol to/from sub-carrier data by using an IFFT/FFT operation, a DAC/ADC for converting an analog/digital signal to/from a digital/analog signal, and an RF processor for transforming a base-band signal to/from an RF signal. Further, the transceiver 309 processes a message exchanged between the SS and the BS by using a corresponding message used in the communication system, and thus transmits/receives it through an antenna.

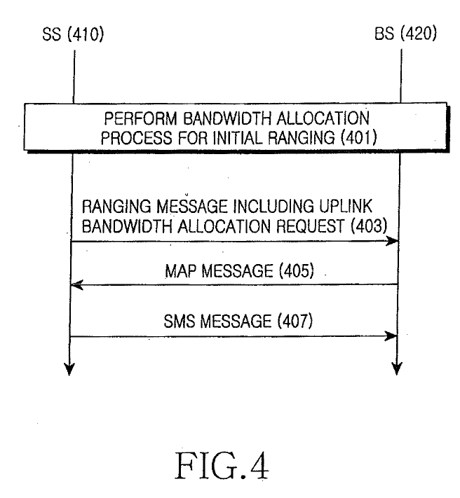

FIG. 4 illustrates a process of exchanging signals between an SS and a BS in a broadband wireless communication system when uplink data is transmitted according to an exemplary embodiment of the present invention. It will be assumed hereinafter that the uplink data is an SMS message.

Referring to FIG. 4, an SS 410 for operating in the idle state transmits a ranging code to a BS 420 so as to allocate a bandwidth for initial ranging. As a result, the BS 420 allocates the bandwidth for initial ranging to the SS 410 in step 401.

After the bandwidth is allocated, the SS 410 transmits a ranging message including an uplink bandwidth allocation request for the SMS message to the BS 420. That is, the SS 410 transmits the ranging message to the BS 420 by using the TLV elements shown in the aforementioned Tables 1 and 2 in step 403.

Upon receiving the ranging message, the BS 420 allocates a bandwidth according to the bandwidth allocation request included in the ranging message. Further, the BS generates an MAP message including the bandwidth allocation information and broadcasts the MAP message to a plurality of SSs. At this time, the SS 410 does not have CID because a registration process is not performed. Thus, the BS 420 allocates the bandwidth by using an assignable fast ranging IE by using a MAC address in step 405.

Upon receiving the MAP message, the SS 410 determines the uplink bandwidth allocated using the MAP message, and transmits the SMS message by using the allocated bandwidth in step 407.

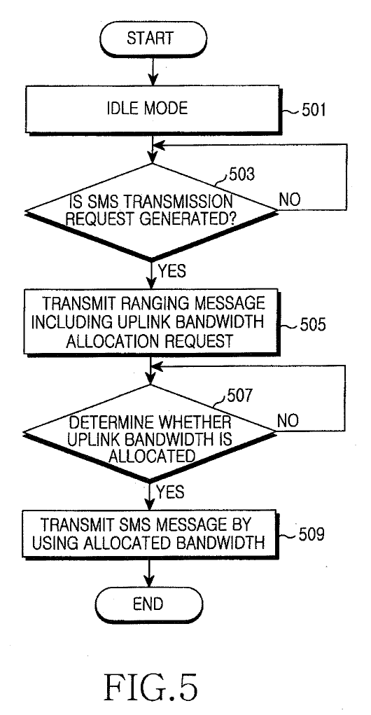

FIG. 5 is a flowchart illustrating a process of transmitting uplink data by an SS in a broadband wireless communication system according to an exemplary embodiment of the present invention. It will be assumed hereinafter that the uplink data is an SMS message.

Referring to FIG. 5, the SS is in an idle mode in step 501. In the idle mode, only the most essential signals are periodically exchanged between the SS and a BS, for example, when location information of the SS is updated, or when downlink data is detected. A CID is not allocated to the SS operating in the idle mode, and thus data communication cannot be made in the idle mode.

Next, in step 503, the SS determines whether an SMS message transmission request is generated. For example, the SMS message transmission request may be determined by user's manipulation or by using data temporarily stored in a transmission buffer.

When the SMS message transmission request is generated, the SS transmits a ranging message including an uplink bandwidth allocation request for the transmission of the SMS message in step 505. That is, the SS transmits a ranging code for requesting bandwidth allocation for the transmission of an initial ranging message, and is thus allocated with a bandwidth for the ranging message. In addition, by using the TLV elements shown in the aforementioned Tables 1 and 2, the SS configures an RNG-REQ message including information on the generation of uplink data to be transmitted in the idle mode and information on bandwidth request and then transmits the configured message to the BS.

After transmitting the RNG-REQ message, the SS determines whether the uplink bandwidth has been allocated using the MAP message received in step 507.

When the uplink bandwidth has been allocated, the SS transmits the SMS message by using the allocated bandwidth in step 509. Herein, the SS does not have the CID since the SS is in the idle mode. Thus, in order to transmit the SMS message, the SS may use an initial ranging CID (‘0x0000’) which is one of pre-defined general purpose CIDs or may be set to a CID defined to transmit data in the idle mode.

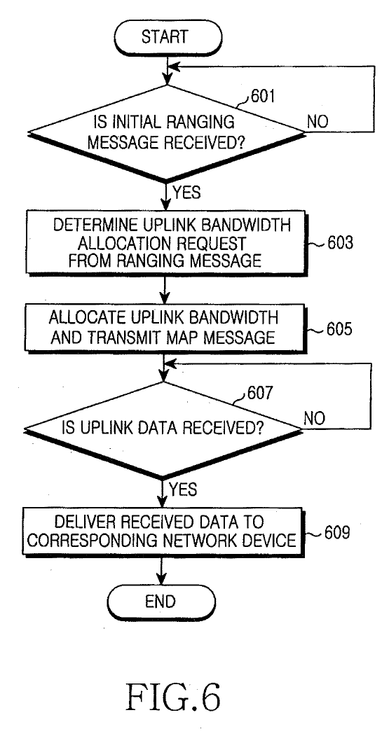

FIG. 6 is a flowchart illustrating a process of receiving uplink data by a BS in a broadband wireless communication system according to an exemplary embodiment of the present invention.

Referring to FIG. 6, the BS determines whether an initial ranging message has been received from an SS operating in the idle mode in step 601. That is, the BS receives a ranging code from the SS, and allocates a bandwidth for the ranging message. In addition, the BS determines whether an RNG-REQ message has been received from the SS.

Upon receiving the ranging message, the BS determines an uplink bandwidth allocation request from the ranging message in step 603. That is, by using the TLV elements shown in the aforementioned Tables 1 and 2, an uplink bandwidth allocation request and a bandwidth request for the transmission of data in the idle mode are determined from the RNG-REQ message.

After determining the uplink bandwidth allocation request, the BS allocates an uplink bandwidth to the SS in step 605. Then, the BS generates an MAP message including the bandwidth allocation information and broadcasts the MAP message to a plurality of SSs. At this time, for the bandwidth allocation, the BS has to know which SS has requested the bandwidth allocation. However, since the SS does not have a CID in the idle mode, the BS identifies the SS by using an SS's MAC address TLV included in the RNG-REQ message. Since the uplink data burst region cannot be allocated without the CID, the BS allocates an assignable fast ranging region by using the MAC address.

After transmitting the MAP, the BS determines whether the uplink data is received in step 607.

Upon receiving the uplink data, the BS delivers the received data to a corresponding network device in step 609. For example, if the received data is an SMS message, the BS delivers the SMS message to an SMS server.

Accordingly, when an SS operating in an idle mode transmits simple uplink data in a broadband wireless communication system, a mode change process can be skipped in which the idle mode is transitioned to a normal mode and which requires a number of steps. Therefore, it is possible to reduce overhead between the SS and a BS and also reduce power consumption of the SS.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus of a subscriber station in a wireless communication system, the apparatus comprising:
a generator for generating a random access message including uplink bandwidth allocation request information when in an idle mode;
a processor for determining an uplink bandwidth allocated by analyzing a bandwidth allocation message received from a base station; and
a transmitter for transmitting data by using the allocated uplink bandwidth.

2. The apparatus of claim 1, wherein the random access message comprises a ranging request message for initial ranging.

3. The apparatus of claim 1, wherein the random access message comprises one or more pieces of information selected from a group consisting of information indicating whether the random access message is a handover message or not, information indicating whether the random access message is location information update message or not, and information indicating whether the random access message is an uplink bandwidth request message or not.

4. The apparatus of claim 3, wherein the random access message comprises Type Length Value (TLV) elements as follows:

| Name | Type | Length | Value |
|---|---|---|---|
| Ranging | 6 | 1 | Bit #0: HO indication |
| Purpose | | | Bit #1: Location Update Request |
| Indication | | | Bit #2: Short Data TX Request |
| | | | Bit #3-7: Reserved |

5. The apparatus of claim 1, wherein the random access message comprises bandwidth request information.

6. The apparatus of claim 5, wherein the random access message comprises TLV elements as follows:

| Name | Type | Length | Value |
|---|---|---|---|
| Uplink | 22 | 2 | Bit #0-10: Bandwidth Request |
| Bandwidth | | | Bit #11-15: Reserved |
| Request | | | |

7. The apparatus of claim 1, wherein the data comprises a Short Message Service (SMS) message.

8. The apparatus of claim 1, wherein a Connection IDentifier (CID) of the data comprises at least one of an initial ranging CID and a CID defined to transmit data in the idle mode.

9. The apparatus of claim 1, wherein the uplink data is transmitted using a fast ranging region among uplink control regions.

10. The apparatus of claim 1, wherein the processor determines the allocated uplink bandwidth by using a Media Access Control (MAC) address of the subscriber station.

11. The apparatus of claim 1, wherein the transmitter transforms sub-carrier data to an Orthogonal Frequency Division Multiplexing (OFDM) symbol through an Inverse Fast Fourier Transform (IFFT) operation.

12. An apparatus of a base station in a wireless communication system, comprising:
a processor for analyzing a random access message received from a subscriber station in an idle mode and determining an uplink bandwidth allocation request of the subscriber station;
a scheduler for allocating a bandwidth according to the uplink bandwidth allocation request; and
a receiver for receiving data from the subscriber station by using the allocated bandwidth.

13. The apparatus of claim 12, wherein the random access message comprises a ranging request message for initial ranging.

14. The apparatus of claim 12, wherein the random access message comprises one or more pieces of information selected from a group consisting of information indicating whether the random access message is a handover message or not, information indicating whether the random access message is location information update message or not, and information indicating whether the random access message is an uplink bandwidth request message or not.

15. The apparatus of claim 14, wherein the random access message comprises Type Length Value (TLV) elements as follows:

| Name | Type | Length | Value |
|---|---|---|---|
| Ranging | 6 | 1 | Bit #0: HO indication |
| Purpose | | | Bit #1: Location Update Request |
| Indication | | | Bit #2: Short Data TX Request |
| | | | Bit #3-7: Reserved |
| | | | Value |
| | | | Bit #0-10: Bandwidth Request |
| | | | Bit #11-15: Reserved |

16. The apparatus of claim 12, wherein the random access message comprises bandwidth request information.

17. The apparatus of claim 16, wherein the random access message comprises TLV elements as follows:

| Name | Type | Length | Value |
|---|---|---|---|
| Uplink | 22 | 2 | Bit #0-10: Bandwidth Request |
| Bandwidth | | | Bit #11-15: Reserved |
| Request | | | |

18. The apparatus of claim 12, wherein the data comprises a Short Message Service (SMS) message.

19. The apparatus of claim 12, wherein a Connection IDentifier (CID) of the data comprises at least one of an initial ranging CID and a CID defined to transmit data in the idle mode.

20. The apparatus of claim 12, wherein the scheduler allocates a fast ranging region for an uplink bandwidth allocation request by using the random access message.

21. The apparatus of claim 12, wherein the scheduler allocates an uplink bandwidth by using a Media Access Control (MAC) address of the subscriber station.

22. The apparatus of claim 12, wherein the receiver transforms an Orthogonal Frequency Division Multiplexing (OFDM) symbol to sub-carrier data through a Fast Fourier Transform (FFT) operation.

23. A method of transmitting data by a subscriber station in a wireless communication system, the method comprising:
generating a random access message including uplink bandwidth allocation request information when in an idle mode;
determining an uplink bandwidth allocated by analyzing a bandwidth allocation message received from a base station; and
transmitting data by using the allocated uplink bandwidth.

24. The method of claim 23, wherein the random access message comprises a ranging request message for initial ranging.

25. The method of claim 23, wherein the random access message comprises one or more pieces of information selected from a group consisting of information indicating whether the random access message is a handover message or not, information indicating whether the random access message is location information update message or not, and information indicating whether the random access message is an uplink bandwidth request message or not.

26. The method of claim 25, wherein the random access message comprises Type Length Value (TLV) elements as follows:

| Name | Type | Length | Value |
|---|---|---|---|
| Ranging | 6 | 1 | Bit #0: HO indication |
| Purpose | | | Bit #1: Location Update Request |
| Indication | | | Bit #2: Short Data TX Request |
| | | | Bit #3-7: Reserved |

27. The method of claim 23, wherein the random access message comprises bandwidth request information.

28. The method of claim 27, wherein the random access message comprises TLV elements as follows:

| Name | Type | Length | Value |
|---|---|---|---|
| Uplink | 22 | 2 | Bit #0-10: Bandwidth Request |
| Bandwidth | | | Bit #11-15: Reserved |
| Request | | | |

29. The method of claim 23, wherein the data comprises a Short Message Service (SMS) message.

30. The method of claim 23, wherein a Connection IDentifier (CID) of the data comprises at least one of an initial ranging CID and a CID defined to transmit data in the idle mode.

31. The method of claim 23, wherein the uplink data is transmitted using a fast ranging region among uplink control regions.

32. The method of claim 23, wherein the determining of the uplink bandwidth allocated comprises determining the allocated uplink bandwidth by using a Media Access Control (MAC) of the subscriber station.

33. The method of claim 23, wherein the transmitting of the data comprises transforming sub-carrier data to an Orthogonal Frequency Division Multiplexing (OFDM) symbol through an Inverse Fast Fourier Transform (IFFT) operation.

34. A method of receiving data by a base station in a wireless communication system, the method comprising:
determining an uplink bandwidth allocation request of a subscriber station by analyzing a random access message received from the subscriber station in an idle mode;
allocating a bandwidth according to the uplink bandwidth allocation request; and
receiving data from the subscriber station by using the allocated bandwidth.

35. The method of claim 34, wherein the random access message comprises a ranging request message for initial ranging.

36. The method of claim 34, wherein the random access message comprises one or more pieces of information selected from a group consisting of information indicating whether the random access message is a handover message or not, information indicating whether the random access message is location information update message or not, and information indicating whether the random access message is an uplink bandwidth request message or not.

37. The method of claim 36, wherein the random access message comprises Type Length Value (TLV) elements as follows:

| Name | Type | Length | Value |
|---|---|---|---|
| Ranging | 6 | 1 | Bit #0: HO indication |
| Purpose | | | Bit #1: Location Update Request |
| Indication | | | Bit #2: Short Data TX Request |
| | | | Bit #3-7: Reserved |

38. The method of claim 34, wherein the random access message comprises bandwidth request information.

39. The method of claim 38, wherein the random access message comprises TLV elements as follows:

| Name | Type | Length | Value |
|---|---|---|---|
| Uplink | 22 | 2 | Bit #0-10: Bandwidth Request |
| Bandwidth | | | Bit #11-15: Reserved |
| Request | | | |

40. The method of claim 34, wherein the data comprises a Short Message Service (SMS) message.

41. The method of claim 34, wherein a Connection IDentifier (CID) of the data comprises at least one of an initial ranging CID and a CID defined to transmit data in the idle mode.

42. The method of claim 34, wherein the determining of the uplink bandwidth allocation request comprises allocating a fast ranging region for an uplink bandwidth allocation request by using the random access message.

43. The method of claim 34, wherein the allocating of the bandwidth comprises allocating an uplink bandwidth by using a Media Access Control (MAC) address of the subscriber station.

44. The method of claim 34, wherein the receiving of the data comprises transforming an Orthogonal Frequency Division Multiplexing (OFDM) symbol to sub-carrier data through a Fast Fourier Transform (FFT) operation.
